(19) United States
(12) Patent Application Publication
(10) Pub. No.: US 2006/0148982 A1
(43) Pub. Date: Jul. 6, 2006

(54) Drug delivery

(76) Inventors: Ijeoma Uchegbu, Glasgow (GB); Andreas Schatzlein, Glasgow (GB); Woei Ping Cheng, Aberdeen (GB)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/528,602

(22) PCT Filed: Sep. 22, 2003
(86) PCT No.: PCT/GB03/04036

§ 371 Date: Sep. 29, 2005

(30) Foreign Application Priority Data
Sep. 20, 2002 (GB) 0221942.6

(51) Int. Cl. C08G 63/91; C08G 73/00

(52) U.S. Cl. 525/54.2; 528/422

(57) ABSTRACT

This invention relates to the delivery of drugs. In particular, this invention relates to the oral delivery of poorly soluble drugs using novel amphiphilic polymers with both solubilising and absorption enhancing properties.

### FIELD OF INVENTION

This invention relates to the delivery of drugs. In particular, this invention relates to the oral delivery of poorly soluble drugs using novel amphiphilic polymers with both solubilising and absorption enhancing properties.

### BACKGROUND OF INVENTION

The oral delivery of poorly soluble drugs is usually accomplished with oil based formulations such as microemulsions (Dunn, C. J., Wagstaff, A. J., Perry, C. M., Plosker, G. L., Goa, K. L., 2001, Cyclosporin—An Updated Review of the Pharmacokinetic Properties, Clinical Efficancy and Tolerability of a Microemulsion-Based Formulation Neoral R(1) in Organ Transplantation, Drugs 61: 1957-2016; and Porter, C. J. H., Charman, W. N., 2001, In vitro Assessment of Oral Lipid Based Formulations, Advanced Drug Delivery Reviews 50: S127-S147) or low molecular weight surface active agents (BalandraudPieri, N., Queneau P. E., Caroli Bosc, F. X., BertaultPeres, P., Montet, A. M., Durand, A., Montet, J. C. 1997, Effects of Tauroursodeoxycholate Solutions on Cyclosporin and Bioavailability in Rats, Drug Metabolism and Disposition 25: 912-916; Guo, J. X., Ping, Q. N., Chen, Y. 2001, Pharmacokinetic Behaviour of Cyclosporin A in Rabbits by Oral Administration of Lecithin Vesicle and Sandimmun Neoral, International Journal of Pharmaceutics 216: 17-21). Poorly soluble drugs are those drugs that are identified in the British Pharmacopoeia as “practically insoluble” (Medicines Commission, British Pharmacopoeia, The Stationary Office, London, 1998). Such drugs have an aqueous solubility of less than 0.1 mg per millilitre of solvent (such as water) at a temperature of about 15° C.-20° C.

Previous attempts to promote oral absorption of poorly soluble drugs such as cyclosporin, have involved the use of oil and/or surfactant (Dunn, C. J., Wagstaff, A. J., Perry, C. M., Plosker, G. L., Goa, K. L., 2001, Cyclosporin—An Updated Review of the Pharmacokinetic Properties Clinical Efficacy and Tolerability of a microemulsion-Based Formulation Neoral R(1) in Organ Transplantation, Drugs 61: 957-2016; and Porter, C. J. H., Charman, S. A., Williams, R. D., Bakalova, M. B., Charman, W. N., 1996, Evaluation of Emulsifiable Glasses for the Oral Administration of the Cyclosporin in Beagle Dogs, International Journal of Pharmaceutics 141: 227-237), bile salt (BaladraudPieri, N., Queneau, P. E., CaroliBosc F. X., BertaultPeres, P., Montet, A. M., Durand, A., Montet, J. C., 1997, Effects of Tauroursodeoxycholate Solutions on Cyclosporin and Bioavailablity in Rats, Drug Metabolism and Disposition 25:912-916), phospholipid based systems (Guo, J. X., Ping, Q. N., Chen, Y., 2001, Pharmacokinetic Behaviour of Cyclosporin A In Rabbits by Oral Administration of Lecithin Vesicle and Sandimmun Neoral, International Journal of Pharmaceutics 21: 17-21; and Leigh, M., Hoogevest, P. V., Tiemiessem, H., 2001 Optimising the Oral Bioavailablity of the Poorly Water Soluble Drug Cyclosporin A Using Membrane Lipid Technology, Drug Delivery and Sciences 1: 73-77) or cyclodextrins (Miyake, K., Arima, H., Irie, T., Hirayma, F., Uekama, K., 1999, Enhanced Absorption of Cyclosporin A by Complexation with Dimethyl-Beta-Cyclodextrin in Bile duct-Cannulated and Non-Cannulated Rats, Biological and Pharmaceutical Bulletin 22: 66-72). Although a nanocapsule formed during in-situ polymerisation has also been proposed for cyclosporin delivery, this technique has difficulties in delivering the drug (Bonduelle, S., Carrier, M., Pimienta, C., Benoit, J. P., Lenaerts, B., 1996, Tissue Concentration of Nanoencapsulted Radiolabelled Cyclosporin Following Peroral Delivery in Mice or Opthalmic Application in Rabbits, European Journal of Pharmaceutics and Biopharmaceutics, 42: 31-319).

Cyclosporin is a lipophilic immunosuppressant used to treat transplant and autoimmune disease patients. Cyclosporin is poorly soluble in a variety of solvents and is currently administered as a micro-emulsion formulation.

It is an object of embodiments of the present invention to obviate or mitigate at least one or more of the aforementioned problems.

It is a further object of embodiments of the present invention to improve delivery of poorly soluble drugs to a recipient.

### SUMMARY OF THE INVENTION

According to a first aspect of the present invention there is provided a polyethylenimine polymer according to the following formula:

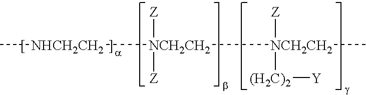

wherein
α is between 0 to 90%;
β is between 0 to 100%;
γ is between 0 to 50%;

wherein α+β+γ=100%; and

the Z groups are hydrophobic and are independently hydrogen or any linear or branched, substituted or unsubstituted, or cyclo form of any hydrophobic substituent; and

Y may represent a hydrophilic substituent.

It should be understood that the monomer units identified with α, β and γ may form any arrangement in the polyethylenimine polymer. The arrangement of the α, β and γ units may therefore be random or in a block copolymer form such as αβγαβγαβγ etc. This is identified above by the dashed line between the different monomer units.

The polyethylenimine polymer may be linear or branched.

The ratios for α, β, γ are numerical ratios.

Typically, the Z groups may independently be selected from any of the following hydrophobic substituents: an alkyl, an alkenyl, and alkynyl, an aryl, an acyl, a hydroxy alkyl, a hydroxy acyl, polyethylene glycol or any sugar.

The Z groups may independently be any linear or branched, substituted or unsubstituted, or cyclo form of the following alkyl, alkenyl, alkynyl, aryl, acyl, hydroxy alkyl, hydroxy acyl, polyethylene glycol or any sugar groups: C₁-C₂₀; C₁-C₁₂; C₁-C₆ or C₁.

The Z groups may be C₁-C₄ linear alkyl groups.

Y may represent any of the following: —NH₂; —NHA; —N⁺R₁R₂R₃; and —N⁺R₁R₂A.
R₁, R₂, or R₃ may be selected from any of the following substituents: an alkyl, an alkenyl, an alkynyl, an aryl, an acyl, a hydroxy alkyl, a hydroxy acyl, polyethylene glycol or any sugar.

R₁, R₂ and R₃ may independently be any linear or branched, substituted or unsubstituted, or cyclo form of the following alkyl, alkenyl, alkynyl, aryl, acyl, hydroxy alkyl, hydroxy acyl, polyethylene glycol or any sugar groups: C₁-C₂₀; C₁-C₁₂; C₁-C₆ or C₁.

Typically, R₁, P, and R₃ are C₁-C₄ linear alkyl groups.

All of R₁, R₂ and R₃ may be CH₃.

Conveniently there may be between 1 and a maximum of 3 R substituents on any single nitrogen. This allows for primary, secondary and tertiary amines.

The groups A may be selected from any of the following linear or branched, substituted or unsubstituted, or cyclo groups: C₁-C₃₀; C₈-C₂₄; or C₁₂-C₁₆.

Typically, the groups A may be a linear C₁₂-C₁₆ alkyl group.

In particular, A may be CH₃(CH₂)₁₅.

The ratio of quaternary ammonium nitrogens to nitrogens of amino groups may be selected from any of the following: 0.01%-100%; 10%-90%; 30%-70%; 40%-60%; 50%-90% or 60%-80%. The preferred range is 40% -90%. A high proportion of quaternary ammonium groups promotes solubilisation of both the polyethylenimine polymer and a hydrophobic drug.

The parent polyethylenimine compound used to make the polyethylenimine polymer may have an average molecular weight of about 2-50 kD, or more particularly, of about 10-25 kD.

The polyethylene polymer may have an average molecular weight of about 10-25 kD.

The polyethylenimine polymer may produce hydrophobic domains. Hydrophobic domains are areas of the molecule's self-assembly where hydrophobic compounds or compounds which are poorly soluble in water are able to reside and thus become solubilised with an aqueous disperse phase. The level of hydrophobic modification may be from 0.01-50%, 0.1-20% or 1-10% of amino groups. The preferred level of hydrophobic modification is 1-10% of amino groups.

All possible monomeric subunits in accordance with the structure as defined in formula I are shown in FIG. 1:

wherein

m is between 0-90%;

n is between 0-100%;

p is between 0-50%;

q is between 0-50%;

u is between 0-50%;

v is between 0-50%;

w is between 0-20%;

x is between 0-20%;

y is between 0-20%; and

z is between 0-20%;

wherein, m+n+p+q+u+v+w+x+y+z 100%; and

A, R₁, R₂, R₃ and Z are as defined above.

It should be appreciated that the monomer units m, n, p, q, u, v, w, x, y and z may be arranged in any order.

The ratios for m, n, p, q, u, v, w, x, y and z are numerical ratios.

Typically, if m=0% then n is not equal to 0%.

Typically, if n=0% then m is not equal to 0%.

Typically, if p=0% then q+u+v+w+x+y+z does not equal 0%.

Typically, if q=0% then p+u+v+w+x+y+z does not equal 0%.

Typically, if u=0% then p+q+v+w+x+y+z does not equal 0%.

Typically, if v=0% then p+q+u+w+x+y+z does not equal 0%.

Typically, if w=0% then x+y+z+n does not equal 0%.

Typically, if x=0% then w+y+z+n does not equal 0%.

Typically, if y=0% then w+x+z+n does not equal 0%.

Typically, if z=0% then w+x+y+n does not equal zero.

Conveniently, m+n lies between 50 to 100%.

Conveniently, p+q+u+v lies between 20 to 50%.

Conveniently, w+x+y+z lies between 0.01 to 10%.

It is possible that polyethylenime may be linear (n=100) or branched as shown in FIG. 1. If n=0%, however, then m must be equal to a value greater than 0% as this allows for the branched material with no backbone quaternisation on erstwhile secondary amines.

It is possible that p, q, u, V, w, x, y or z may be equal to 0%. However, the sum total of p, q, U, V, W, X, y and z may be equal to a value greater than 0%, as this allows for the branched compound to be included.

Alternatively, w, x, y or z may be equal to 0%. However, the sum total of w, x, y or z may not be equal to 0%. This allows for a hydrohobically substituted branched compound.

Typically, m+n=60%, w+x+y+z=6%, and p+q+u+v=34%. Using these ranges defines the quaternary ammonium cetyl polyethylenimine found in the Example Section of the present application.

According to a second aspect of the present invention there is provided a method of forming a polyethylenimine polymer according to the first aspect by reacting a polyethylenimine compound formed from the polymerisation of ethylenimine with a first organo halide to form an organo side chain on the polyethylenimine compound, and then a second organo halide to react with an amino group on the polyethyleneimine compound.

The polyethylenimine used may be branched or linear.

Branched polyethylenimine may be prepared by the acid catalysed polymerisation of, for example, aziridine (ethyleneimine) (Dick, C. R., Ham, G. E., J. Macromol. Sci. 1970, A4, 1301-1314; von Harpe, A., Petersen, H., Li, Y., Kissel, T., J. Control. Rel. 2000, 69, 309-332). Linear polymers may be prepared by controlling the conditions of polyethylenimine polymerisation (Zhuk, D. S., Gembitsky, P. A., Alexandrovich, A. I., U.S. Pat. No. 4,032,480).

The first organo halide may be any linear or branched, substituted or unsubsituted, or cyclo form of any alkyl, alkenyl, alkynyl, aryl or acyl halide or any hydrophilic halide. The halide may be any of fluoride, chloride, bromide or iodide.

The organo group of the first organo halide may be selected from any of the following linear or branched, substituted or unsubstituted, or cyclo groups: C₁-C₃₀; C₈-C₂₄; or C₁₂-C₁₆.

Typically, the first organo halide is a linear C₁₂-C₁₆ alkyl halide.

In particular, the first organo halide may be cetyl bromide (e.g. CH₃(CH₂)₁₅ Br).

The second organo halide may be any alkyl, alkenyl, alkynyl, aryl or acyl halide or any hydrophilic halide. The halide may be any of fluoride, chloride, bromide or iodide.

The organo group of the second organo halide may be selected from any of the following linear or branched, substituted or unsubstituted, or cyclo groups: C₁-C₂₀; C₁-C₆; or C₁.

Typically, the second organo halide is a linear C₁-C₆ alkyl halide. In particular, the second organo halide may be methyl iodide.

The polyethylenimine compound and first organo halide may be mixed in an organic solvent such as tetrahydrofuran, which may then be refluxed. The refluxing may occur in an alcoholic solution of, for example, sodium hydroxide. Cetyl polyethylenimine may then be isolated and may then be reacted with the second organo halide.

The second organo halide may be added in the presence of, for example, a metal hydroxide (e.g. sodium hydroxide), a metal halide (e.g. sodium iodide) and an alcohol (e.g. methanol).

The polyethylenimine polymer may then be obtained by washing, dialysis and using an ion exchange column.

Further quaternisation may be obtained by adding more of the second organo halide.

The formed polyethylenimine polymer may be that as represented in FIG. 1.

It is also possible to prepare a substituted linear polyethylenimine with the end nitrogens protected, subsequently deprotect the terminal amines and then attach this substituted linear polyethylenimine to the branched molecule and follow the whole conjugation step with a quaternary ammonium step.

According to a third aspect of the present invention there is provided a composition comprising a polyethylenimine polymer according to the first aspect and a pharmaceutically acceptable carrier.

Pharmaceutically acceptable carriers are well known to those skilled in the art and include, but are not limited to, 0.1 M and preferably 0.05 M phosphate buffer or 0.9% w/v saline. Additionally, such pharmaceutically acceptable carriers may be aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's or fixed oils. Preservatives and other additives may also be present, such as, for example, antimicrobials, antioxidants, chelating agents, inert gases and the like.

Typically, the ratio of polyethylenimine polymer to pharmaceutically acceptable carrier ranges from any of the following: 0.0001-100 w.v., 0.005-50 w.v.; 0.001-30 w.v.; 0.001-10 w.v.; or 0.01-1 w.v.

According to a fourth aspect of the present invention there is provided a pharmaceutical composition comprising a polyethylenimine polymer according to the first aspect and a drug.

The drug may be poorly soluble in aqueous solvents such as water. The drug may be administered to a patient as a solution or a particulate formulation.

The drug may be selected from any of the following: cyclosporin; steroids such as prednisolone, oestradiol, testosterone; drugs with multicyclic ring structures which lack polar groups such as paclitaxel; and drugs such as etoposide.

Typically, the ratio of the polyethylenimine polymer to the drug may be selected from any of the following: 0.001-100%; 0.1-100%; 1-100%; 10-90%; 30-70%.

The pharmaceutical composition may also comprise a pharmaceutically acceptable carrier.

Typically, the ratio of polyethylenimine polymer to drug to pharmaceutically acceptable carrier may be in the range of 5-20 mg:0.5-5 mg:0.5-5 mL or 5-20 mg: 0.5-5 mg:0.5-5 g. In particular, the ratio of polyethylenimine polymer to drug to pharmaceutically acceptable carrier may be about 10 mg:2 mg:1 mL or about 10 mg:2 mg:2 g.

The pharmaceutical composition may be in the form of any of the following: tablets, suppositories, liquid capsule, powder form, or a form suitable for pulmonary delivery.

When tablets are used for oral administration, typically used carriers include sucrose, lactose, mannitol, maltitol, dextran, corn starch, typical lubricants such as magnesium stearate, preservatives such as paraben, sorbin, antioxidants such as ascorbic acid, α-tocopheral, cysteine, disintegrators or binders. When administered orally as capsules, effective diluents include lactose and dry corn starch. A liquid for oral use includes syrup, suspension, solution and emulsion, which may contain a typical inert diluent used in this field, such as water. In addition, sweeteners or flavours may be contained.

Suppositories may be prepared by admixing the compounds of the present invention with a suitable non-irritative excipient such as those that are solid at normal temperature but become liquid at the temperature in the intestine and melt in rectum to release the active ingredient, such as cocoa butter and polyethylene glycols.

The dose of the polymer can be determined on age, body weight, administration time, administration method, combination of drugs, the level of condition of which a patient is undergoing therapy, and other factors. While the daily does may vary depending on the conditions and body weight of patients, the species of active ingredient, and administration route, in the case of oral use, the daily does may be about 0.1-100 mg/person/day, preferably 0.5-30 mg/person/day.

According to a fifth aspect of the present invention there is provided a method of dissolving poorly soluble drugs suitable for oral delivery, using a preformed polymer.

By preformed polymer herein is meant a polymer which already exists and does not need to be formed during an in-situ polymerisation step.

The preformed polymer may be a polyethylenimine polymer according to the first aspect.

The poorly soluble drug may be selected from any of the following: cyclosporin; steroids such as prednisolone; oestradiol; testosterone; drugs with multicyclic ring structures which lack polar groups such as paclitaxel; drugs such as etoposide.

The fact that R₁, R₁, R₃ and R₄ may be long chain alkyl groups or other hydrophobic groups makes it possible for the polyethylenimine polymer according to the first aspect to dissolve poorly soluble drugs in aqueous media.

The preformed polymer may also be used to dissolve polar (aqueous soluble) materials within hydrophobic media.

According to a sixth aspect of the present invention there is provided use of a preformed polymer according to the fifth aspect in dissolving poorly soluble drugs in the preparation of a composition.

The composition may be a pharmaceutical composition comprising a drug and/or a pharmaceutically acceptable carrier.

### BRIEF DESCRIPTION OF THE DRAWINGS

Embodiments of the present invention will now be described, by way of example only, with reference to the accompanying drawings in which:

FIG. 1 is a representation of a polyethyleneimine polymer formed according to the present invention; and

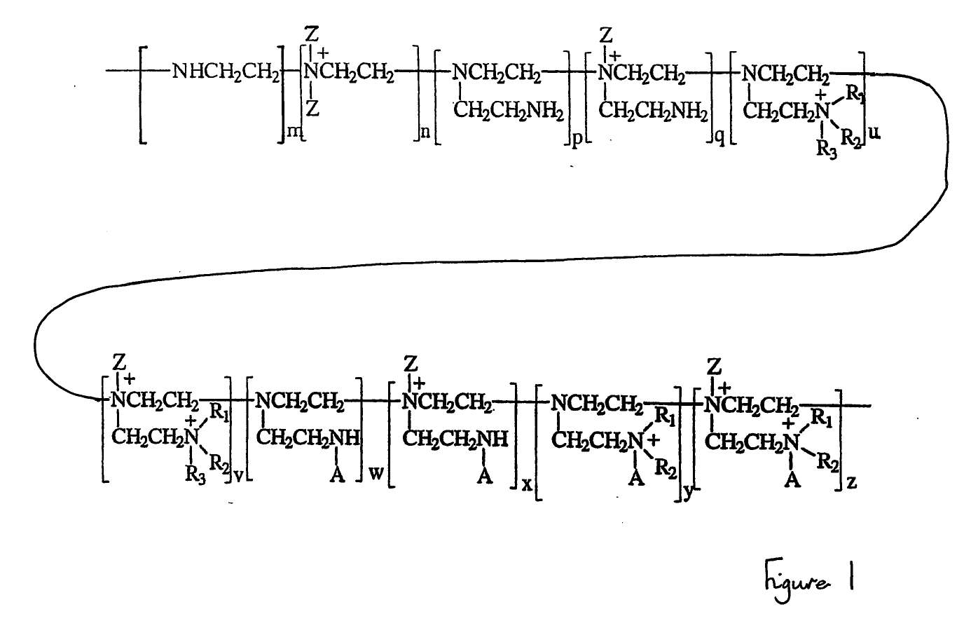

FIG. 2 is a Transmission Electron Microscopy (TEM) image of quaternary ammonium cetyl polyethyleneimine (QCPEI2) and cyclosporin nanoparticles.

### EXAMPLES

### Example 1

### Synthesis of Quaternary Ammonium Cetyl Polyethylenimine (OCPEI)

Alkylation of polyethylenimine was carried out according to a previously reported method (Noding, G., Heitz, W., 1998, Amphiphilic Polyethylenimines Based on Long-Chain Alkyl Bromide Macromolecular Chemistry and Physics 199: 637-1644). Briefly, polyethylenimine (M_{w}=25 kD, 5 g) was alkylated by refluxing with cetyl bromide (1.8 g) and tetrahydrofuran (50 ml) for 48 hours, followed by the addition of an alcoholic solution of sodium hydroxide (4.8 g in 25 ml methanol), and a further reflux period of 24 hours. Sodium bromide was removed by filtration and the product isolated by evaporation of the solvent, exhaustive dialysis and freeze-drying. 0.6 g of cetyl polyethylenimine was then quaternised by reaction with methyl iodide (2.6 ml) in the presence of sodium hydroxide (0.23 g), sodium iodide (0.28 g) and methanol (100 ml) for 3 hours at 36° C. The product was isolated by precipitation in ether (400 ml), washing with ethanol, exhaustive dialysis of an ethanolic solution and elution through an ion exchange column to isolate the hydrochloride salt.

A yellow cotton wool like solid which is the quaternary ammonium cetyl polyethyleneimine (QCPEI1) was obtained on freeze drying.

A further quaternisation of quaternary ammonium cetyl polyethyleneimine (QCPEI1) produced a doubly quaternerised compound, i.e. di-quaternary ammonium cetyl polyethyleneimine (QCPEI2).

Characterisation of Quaternary Ammonium Cetyl Polyethylenimine

¹H NMR and ¹H correlation spectroscopy as well as ¹³C NMR experiments (Bruker, AMX 400 MHz spectrometer, Bruker Instruments UK) were carried out on the quaternary cetyl polyethyleneimine in deuterated methanol. Elemental analysis was carried out on the products using a Perkin Elmer 2400 analyser.

Polymer Aggregation

The aggregation of an aqueous solution of the polymers was studied using a pyrene probe for hydrophobic domains (see Kalyanasundaram, K., Thomas, J. K., 1977, Environmental Effects on the Vibronic Band Intensities in Pyrene Monomer Fluorescence and the Application to Studies of Micellar Systems, Journal of the American Chemical Society 99: 2039-2044). Fluorescence scans (excitation=340 nm) were performed on various concentrations of the polymer dissolved in an aqueous pyrene solution (2 μM). The ratio of the intensity of the third and first peaks (I₃/I₁) was used to assess the hydrophobicity of the pyrene environment which is an indirect probe for polymer association.

Polymer aggregation was also assessed by recording the hypsochromic shift in the UV absorption spectrum of methyl orange (Lieske, A., Jaeger, W., 1999, Block Copolymers Containing Polysoap Blocks, Tenside Surfactants Detergents 36: 155-161) in 25 μM in 0.02M borate buffer when encapsulated within a hydrophobic environment. UV absorption scans (300-600 nm) were performed on various concentrations of the polymer dissolved in the methyl orange-borate solution and the wavelength of maximum absorbance noted.

TABLE 1
Quaternary ammonium cetyl polyethyleneimine (QCPEI1) aggregation
in aqueous solution as measured by the increase in (I₃/I₁)
ratio in the pyrene fluorescence and by the hypsochromic
shift in the methyl orange spectra

| | QCPEI1 | | QCPEI2 |
|---|---|---|---|
| | Methyl Orange | | Methyl Orange |
| | wavelength of | | wavelength of |
| QCPEI1 | maximum | QCPEI2 | maximum |
| I3/I1 ratio | absorbance | I3/I1 ratio | absorbance |
| (QCPEI1 | (QCPEI1 | (QCPEI2 | (QCPEI2 |
| concentration | concentration | concentration | concentration |
| in mg mL⁻¹) | in mg mL⁻¹) | in mg mL⁻¹) | in mg mL⁻¹) |
| 0.64 (0) | 465 (0) | 0.61 (0) | 465 (0) |
| 0.88 (0.87) | 450 (0.50) | 0.823 (0.81) | 456 (0.55) |
| 0.89 (1.73) | 452 (1.52) | 0.862 (1.621) | 450 (1.63) |
| 0.92 (3.73) | 452 (3.73) | 0.871 (3.24) | 458 (3.70) |
| 0.98 (7.04) | 454 (7.80) | 0.853 (4.37) | 455 (7.85) |
| | | 0.926 (6.49) | 456 (14.25) |

The synthesis of the cetyl polyethylenimine was confirmed by a proton NMR and assignments were made as follows:

δ=0.87=CH₃ (cetyl), δ1.25=CH₂ (cetyl), δ1.45=CH₂—N (cetyl), δ2.7-2.8=CH₂—N (cetyl and polyethylenimine). Quaternisation of cetyl polyethylenimine to produce quaternary ammonium cetyl polyethylenimine was confirmed by ¹³C NMR: δ14.6=CH₃ (cetyl), δ23.9=CH₂ (cetyl), δ52.5 and 54.8=CH₃(CH₃N⁺), δ58.8 and 63.5=CH₂N and CH₂N+ (polyethylenimine) and ¹H NMR−δ0.90=CH₃ (cetyl), δ1.3=CH₂ (cetyl), δ1.47=CH₂ (cetyl), δ1.85=CH₂—N (cetyl), δ2.5-4.7=CH₂N, CH₂N⁺ and CH₃N⁺.

The yields of cetyl polyethylenimine, quaternary polyethyleneimine (QCPEI1) and di-quaternary cetyl polyethyleneimine (QCPEI1) were 67%, 85% and 46%, respectively.

The degree of cetylation was found to be 5.2% of all amine groups using elemental analysis data. The degree of conversion of amines to quaternary ammonium moieties was approximately 64% for quaternary cetyl polyethylenimine and 81% for di-quaternary cetyl polyethylenimine.

Both quaternary ammonium polymers aggregate to produce hydrophobic domains in aqueous solution (See Table 1). This is shown by the increase in the I3/I1 values and also by the shift to a lower wavelength of the methyl orange peak. These hydrophobic domains serve to solubilise poorly aqueous soluble (hydrophobic) drugs such as cyclosporin; in the case of the less quaternised variant-QCPEI1 which forms a clear micellar liquid with cyclosporin, when freshly prepared (Table 1), effectively encapsulating cyclosporin within the hydrophobic domains.

### Example 2

### Preparation of Quaternary Cetyl Polyethylenimine-Cyclosporin Formulations

Quaternary cetyl polyethylenimine polymers were dissolved by probe sonication on ice (Soniprep Instruments, UK) followed by the addition of cyclosporin, which was incorporated into the polymer solution by probe sonication. Formulations were stored for up to 13 days and observed for particle formation. Particulate formations were sized by photon correlation spectroscopy, imaged by both transmission electron microscopy (TEM) with negative staining (see Wang, W., Tetley, L., Uchegbu, I. F., 2001. The Level of Hydrophobic Substitution and the Molecular Weight of Amphiphilic Poly-L-Lysine-based Polymers Strongly Affects Their Assembly into Polymeric Bilayer Vesicles, Journal of Colloid and Interface Science 237: 200-207) and freeze fracture electron microscopy (see Uchegbu, I. F., Schatzlein, A. G., Tetley, L., Gray, A. I., Sludden, J., Siddique, S., Mosha, E., 1998, Polymeric Chitosan-Based Vesicles for Drug Delivery, Journal of Pharmacy and Pharmacology 50: 453-458). Clear micellar formulations were filtered with a 0.45 μm filter and the filtered formulations assayed by HPLC using a reverse phase Waters Spherisorb ODS column (25 cm×4.6 mm), eluted with a water, acetonitrile tert-butyl methyl ether, orthophosphoric acid (350:600:50:1). Detection was by UV(λ=210 nm).

TABLE 2
QCPEI-cyclosporin formulations

| | | | % Recovery of cyclosporin from | | | |
|---|---|---|---|---|---|---|
| | | | micellar solutions(a) | | Mean Particle Size (nm) | |
| | | | | After storage | Storage (2-8° C.) | Storage (2-8° C.) |
| | | Initial Mean | | (2-8° C.) | for 4 days followed by | for 3 days followed by |
| | Initial | Particle | Freshly prepared | for 90 days | exposure to room | exposure to 37° C. |
| Formulation | Appearance | Size (nm) | (mean ± s.d.) | (mean ± s.d.) | temperature for 15 min | for 15 min |
| QCPEI1 | Clear | — | 78.7 ± 8.14 | 93.3 ± 6.60 | 558 (n = 3) | 608 (n = 6) |
| | liquid | | (n = 3) | (n = 4) | | |
| QCPEI2 | Colloidal | 310 (n = 4) | — | — | 377 (n = 1) | 512 (n = 3) |

(a)Initial Concentration = 2 mg mL⁻¹
n Denotes number of formulations assayed.

[In Table 2 the blank boxes (represented with a “-”) represent particulate formulations, which cannot be assayed in the same way as micellar formulations].

As shown in Table 1 both quaternary ammonium polymers (i.e. QCPEI1 and QCPEI2) aggregate to produce hydrophobic domains in aqueous solutions. These hydrophobic domains serve to solubilise cyclosporin. In the case of the less quaternerised variant-QCPEI1 forms a clear micellar liquid with cyclosporin, when freshly prepared, effectively encapsulating cyclosporin within hydrophobic domains. However, as shown in Table 2, the polymer exhibits a lower critical solution temperature and becomes less hydrated with increase in temperature resulting in aggregation of the polymeric micelles to form nanoparticles. Furthermore, Table 2 shows storage of QCPEI1 at refrigeration temperature preserved the micellar formulation. The micellar formulation is preserved as analysis of the optically clear samples after storage for 90 days shows that there is no precipation of cyclosporin.

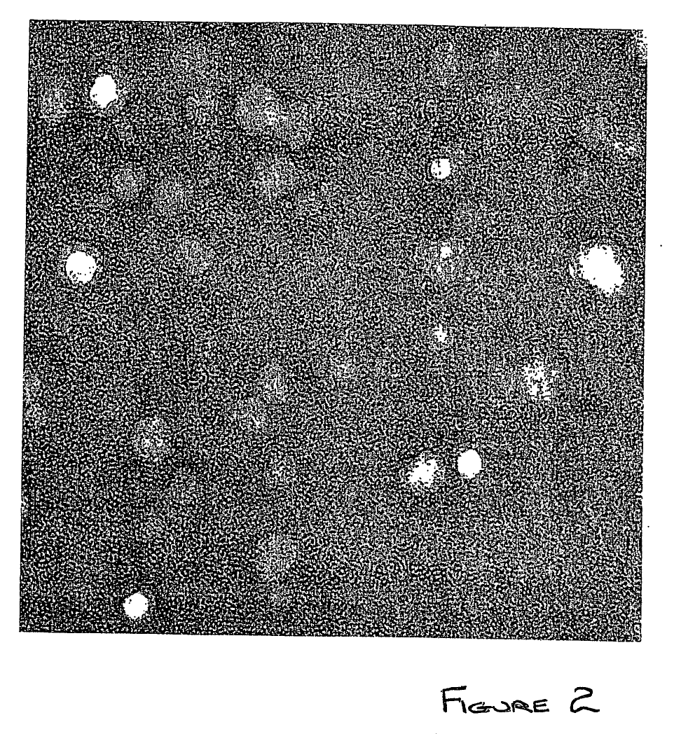

In contrast to QCPEI1, the doubly quaternarised compound QCPEI2, which is less water soluble than QCPEI1 initially formed stable nanoparticles with cyclosporin. FIG. 2 shows that the double quaternarised compound (QCPEI2) does not form micelles with cyclosporin. The size bar shows that the aggregates formed are too large to be micelles although the image could show an aggregate of lots of micelles. These will still be technically nanoparticles as the formulation is not optically clear.

Although the polymer forms micelles within which cyclosporin is solubilised, the polymer exhibits a lower critical solution temperature and becomes less hydrated with increase in temperature resulting in aggregation of the polymeric micelles to form nanoparticles after exposure to elevated temperatures (i.e. removal from the fridge, Table 2). However, storage of QCPEI1 at refrigeration temperature preserved the micellar formulation (Table 2) and there was no conversion of the micelles into nanoparticles. In contrast to QCPEI1, the doubly quaternised compound QCPEI2, which is less water soluble than QCPEI1, initially formed stable nanoparticles with cyclosporin (FIG. 2, Table 2) and does not form the micelles with cyclosporin.

### Example 3

### Oral Administration of Quaternary Cetyl Polyethylenimine-Cyclosporin Formulations

Groups of male Wistar rats (n=4 i.e. the group size, weight=200-220 g) were fasted for 12 hours before dosing and subsequently dosed intragastrically (10 mg kg⁻¹) with an optically clear quaternary cetyl polyethylenimine (QCPEI1)-cyclosporin formulation (10:2); a particulate quaternary cetyl polyethylenimine (QCPEI2)-Cyclosporin (10:2) formulation; Neoral (Registered Trademark) or water. Neoral is a microemulsion formulation of cyclosporin manufactured and marketed by Novartis.

Blood was taken from the tail vein of these anaesthetised rats at 1 hour, 4 hours and 24 hours after dosing. Plasma was separated by centrifugation at 1000 g and stored at −20° C. until analysis could be performed on the samples. Cyclosporin was measured in the plasma samples using a monoclonal antibody radioimmunoassay kit (Cyclo-Trac SP-Whole Body Radioimmunoassay Kit) supplied by Diasorin, UK.

TABLE 3
Blood Levels Following Oral Cyclosporin Dosing

| | Formulations | | |
|---|---|---|---|
| | ngL⁻¹ of cyclosporin in blood | | |
| Time | Neoral ® | QCPEI1 | QCPEI2 |
| 1 h | 1525 ± 267* | 583 ± 284 | 748 ± 482 |
| 4 h | 1521 ± 163 | 1179 ± 360 | 1387 ± 539 |
| 24 h | 346 ± 37 | 315 ± 95 | 295 ± 45 |

*statistically significant difference between groups at the same time point (p < 0.05)

The oral QCPEI1 formulations were well tolerated in rats with no gross adverse events recorded. Plasma levels at the 4 hour time point from the oil free QCPEI formulations were indistinguishable from peak levels obtained using Neoral (Registered Trademark), although Neoral (Registered Trademark) was absorbed faster than the QCPEI formulations shown in Table 3. The amphiphilic polyethyleneimine polymer therefore promotes the absorption of a poorly soluble drug such as cyclosporin.

Within the 37° C. environment of the gut lumen it is assumed, although not wishing to be bound by theory, that the narrow particle formulation prevails for both polymers and that these nanoparticles experience the gradual loss of cationic micellar aggregates still encapsulating their hydrophobic payload. As cationic polymers are known to facilitate transport across epithelial membranes and across cell membranes, these micellar aggregates may also facilitate the intestinal absorption of cyclosporin. The disassociation of the nanoparticle into single micellar aggregates results in the delayed absorption when compared to the oil containing formulation.

### Example 4

### Oral Delivery of Cyclosporin 2

This Example examines the effect of intermediate and low molecular weight quaternary ammonium hexadecyl polyethylenimine on the oral delivery of cyclosporine A.

Materials

Polyethylenimine (Mw=10 kD) was supplied by Polysciences, UK. Polyethylenimine (Mw=1.8 kD), hexadecyl bromide, methyl iodide and sodium iodide were all obtained from Sigma-Aldrich, Co., UK. Ethanol, diethyl ether and tetrahydrofuran were supplied by the Department of Pure and Applied Chemistry, University of Strathclyde.

Methods

Intermediate molecular weight quaternary ammonium cetyl PEI with two different levels of quaternary ammonium modification (Q1₁₀ and Q2₁₀) were synthesised by reacting polyethylenimine (PEI, Mw=10 kD) with both cetyl bromide and methyl iodide as described for QCPEI1 and QCPEI2 respectively in Example 1. Low molecular weight quaternary ammonium cetyl PEI with a high level of quaternary ammonium modification (Q2_{1.8}) was synthesised by reaction of PEI (Mw=1.8 kD) with both cetyl bromide and methyl iodide as described for QCPEI2 in Example 1. Q1₁₀, Q2₁₀, and Q2_{1.8} cyclosporine (2 mg mL⁻¹) formulations, each containing 10 mg mL⁻¹ of the respective amphiphilic PEI were prepared as described in Example 2.

Male Wistar rats (mean weight ═XXg [WPC PLEASE COMPLETE], n=4) were dosed orally with QCPEI1, Q1₁₀, Q2₁₀ or Neoral formulations of cyclosporine (7.5 mg kg⁻¹). Blood was then sampled at various time intervals and cyclosporine analysed in the sampled blood using the radioimmunoassay procedure described in Example 3. In a separate experiment male Wistar rats (mean weight=XXg [WPC PLEASE COMPLETE], n=4) were dosed orally with Q2₁₀, Q2_{1.8}, or Neoral formulations of cyclosporine (10 mg kg⁻¹). A further group was dosed with a dispersion of cyclosporine (10 mg kg⁻¹) in water which was shaken just prior to administration. Blood was sampled from these 4 groups of animals at various time intervals and cyclosporine analysed in blood using the radioimmunoassay procedure described in Example 3.

Results

TABLE 4
Blood levels of cyclosporine after dosing
animals orally with 7.5 mg Kg⁻¹ cyclosporine

| | Blood levels (ng mL⁻¹, n = 4, mean ± s.d.) | | |
|---|---|---|---|
| Formulation | 1 h | 4 h | 24 h |
| Q1₁₀ | 615 ± 351* | 854 ± 376 | 73 ± 38 |
| Q2₁₀ | 1050 ± 456 | 1163 ± 326 | 95 ± 19 |
| QCPEI1 | 576 ± 320* | 799 ± 481 | 84 ± 44 |
| Neoral | 1496 ± 447 | 989 ± 301 | 150 ± 68 |

*Statistically significantly different from Neoral (p < 0.05)

TABLE 5
Blood levels of cyclosporine after dosing animals
orally with 10 mg Kg⁻¹ cyclosporine

| | Blood levels | | |
|---|---|---|---|
| | (ng mL⁻¹, n = 4, mean ± s.d.) | | |
| Formulation | 1 h | 4 h | 24 h |
| Q2_{1.8} | 889 ± 336* | 1677 ± 840 | 461 ± 153^{#} |
| Q2₁₀ | 1213 ± 196*^{#} | 1865 ± 516^{#} | 565 ± 115^{#} |
| Cyclosporine dispersion | 439 ± 345* | 617 ± 277* | 88 ± 43 |
| in water | | | |
| Neoral | 2026 ± 209^{#} | 1915 ± 158^{#} | 475 ± 133^{#} |

*Statistically significantly different from Neoral (p < 0.05).
#statistically significantly different from cyclosporine dispersion in water.

Comment on Results

At the 7.5 mg kg-1 dose level Q2₁₀ had an equivalent bioavailability with Neoral while Q1₁₀ and QCPEI1 delivered less cyclosporine via the oral route after 1 h when compared to Neoral, although cyclosporine levels equivalent to Neoral were delivered at the 4 h and 24 h time points by both Q1₁₀ and QCPEI1.

At the 10 mg kg-1 dose level, all formulations delivered less cyclosporine than Neoral at the 1 h time point although Q2₁₀ improved the absorption of cyclosporine when compared to cyclosporine dispersion in water. At the 4 h time point both Q2₁₀ and Q2_{1.8} were bioequivalent with Neoral whereas due to the high standard deviations obtained with Q2_{1.8}, this formulation was statistically indistinguishable from the cyclosporine dispersion in water. At the 24 h time point all formulations resulted in a greater absorption of cyclosporine when compared to the cyclosporine dispersion in water.

It is clear that polyethylenimine amphiphiles are able to promote the absorption of cyclosporine.

### Example 5

### Stability of Cyclosporin Solutions

This Example relates to assessing the stability of quaternary ammonium polyethylenimine-cyclosporine formulations.

materials

Polyethylenimine (Mw=10 kD) was supplied by Polysciences, UK. Polyethylenimine (MW=25 kD), hexadecyl bromide, methyl iodide and sodium iodide were all obtained from Sigma-Aldrich, Co., UK. Ethanol, diethyl ether and tetrahydrofuran were supplied by the Department of Pure and Applied Chemistry, University of Strathclyde.

Methods

Q1₁₀ was synthesised by reacting polyethylenimine (PEI, Mw=10 kD) with both cetyl bromide and methyl iodide as described for QCPEI1 in Example 1. QCPEI1 was also synthesised as described in Example 1. Q1₁₀ and QCPEI1 Formulations of cyclosporine (2 mg mL⁻¹) containing 10 mg mL⁻¹ of the amphiphilic PEIs were prepared as described in Example 2.

Formulations were then stored in stoppered glass containers at refrigeration temperature (2-8° C.). At various time intervals aliquots were sampled, filtered through a 0.45 μm filter and analysed by high performance liquid chromatography (HPLC). Filtered cyclosporine samples (20 μL) dissolved in acetonitrile, water (1:1) were injected onto a Waters Spherisorb 5 μm, 4.6 mm×250 mm column (Waters Instruments, UK) maintained at 80° C. with a Jones Chromatography Column Heater model 7971 by means of a Waters 717 autosampler and a Waters 515 isocratic pump. The mobile phase was acetonitrile:water:tert-butyl-methyl-ether: phosphoric acid (600:350:50:1) at a flow rate of 1.2 mL min⁻¹. Peak detection was via a Waters 486 variable wavelength UV detector with the wavelength set at 210 nm and data was collected using a Waters 746 data module. A standard curve was prepared using solutions of the drug (1-10 μg mL⁻¹).

Results

| Time Point (days) | QCPEI1 | Q1₁₀ |
|---|---|---|
| 0 | 78.7 ± 8.1 | 80.7 ± 17.7 |
| 7 | 84.6 ± 3.1 | 74.0 ± 8.1 |
| 41 | 93.7 ± 8.8 | 81.9 ± 3.6 |
| 109 | 91.0 ± 6.3 | 79.0 ± 0.6 |
| 181 | 84.4 ± 2.9 | 82.0 ± 2.3 |
| 281 | 89.4 ± 0.42 | 79.0 ± 1.4 |

Comment on Results

Over a 9 month period the level of cyclosporine recovered from amphiphilic PEI formulations Q1₁₀ and QCPEI1 did not differ appreciably from the original levels, indicating that these formulations were stable when stored for 9 months at refrigeration temperatures.

1. A polyethylenimine polymer according to the following formula: 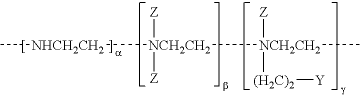
wherein
α is between 0 to 90%;
β is between 0 to 100%;
γ is between 0 to 50%;
wherein α+β+γ=100%; and
the Z groups are hydrophobic and are independently hydrogen or any linear or branched, substituted or unsubstituted, or cyclo form of any hydrophobic substituent; and
Y may represent a hydrophilic substituent.

2. A polyethylenimine polymer according to claim 1 wherein the monomer units identified with α, β and γ form any arrangement in the polyethylenimine polymer.

3. A polyethylenimine polymer according to claim 1 wherein the arrangement of the α, β and γ units are random or in a block copolymer form such as αβγαβγαβγ.

4.-31. (canceled)

32. A method of forming a polyethylenimine polymer according to claim 1 by reacting a polyethylenimine compound formed from the polymerisation of ethylenimine with a first organo halide to form an organo side chain on the polyethylenimine compound, and then a second organo halide to react with an amino group on the polyethylenimine compound.

33. A method according to claim 32 wherein the ethylenimine is branched or linear.

34.-43. (canceled)

44. A composition comprising a polyethylenimine polymer according to claim 1 and a pharmaceutically acceptable carrier.

45. (canceled)

46. A pharmaceutical composition comprising a polyethylenimine polymer according to claim 1 and a drug.

47. A pharmaceutical composition according to claim 46 wherein the drug is poorly soluble in aqueous solvents such as water.

48. A pharmaceutical composition according to claim 46 wherein the drug is selected from any of the following: cyclosporin; steroids such as prednisolone, oestradiol, testosterone; drugs with multicyclic ring structures which lack polar groups such as paclitaxel; and drugs such as etoposide.

49.-57. (canceled)
